(19) United States
(12) Patent Application Publication
(10) Pub. No.: US 2004/0184634 A1
(43) Pub. Date: Sep. 23, 2004

(54) Stomp Stage

(76) Inventor: Zorki Nastasic, Highlands, NC (US)

Correspondence Address: Zorki Nastasic, PO BOX 1721, Highlands, NC, 28741, US

(21) Appl. No.: 10/776,627

(22) Filed: Feb. 9, 2004

Related U.S. Application Data
(60) Provisional application No. 60/446,359, filed on Feb. 11, 2003.

(51) Int. Cl. H04R 9/08; H04R 11/04; H04R 17/02

(52) U.S. Cl. 381/361; 381/122

(57) ABSTRACT

An extremely light and portable stage/platform that while being performed upon, is capable of amplifying the movement of the feet by having a microphone or sound pick-up mounted underneath and subsequently plugged into an amplifying source such as an amplifier or mixer board.

1. The Stomp Stage is a portable stage or platform approximately 2 feet square and 2 inches high with a microphone or sound pick-up mounted underneath so that during a musical or dance performance the rhythm created by the feet can be amplified.

2. The original prototype is made with a piece of 1/2 inch plywood approximately 2 feet square mounted on a frame of wooden 2×2's using nails, screws or glue with an opening on one side where a standard microphone (sans the wind screen) is inserted into a ‘microphone housing’ situated underneath the plywood. The ‘microphone housing’ consists of two 1 inch square wooden rods, six inches long, situated to support the microphone on each side and having two velcro strips attached to the rods, situated to strap across the microphone to secure it in place. Also having a piece of screen mounted on the end of the rods to prevent the microphone from slipping all the way through once inserted.

3. The ideal design for the Stomp Stage would be a very light, one piece unit cast in plastic, metal, hard rubber or any other moldable, hardening material using one or two microphones or their components permanently mounted underneath and encaged in a protective housing.

4. If a musician was performing and stomping on a Stomp Stage, the desired effect would be similar to a bass drum.

5. If a dancer was performing on a Stomp Stage, the desired effect would be to amplify the rhythm created by their feet while dancing.

### REFERENCES CITED

U.S. Pat. Documents:

| | | | |
|---|---|---|---|
| 4168646 | September 1979 | May | 84/723. |
| 5602354 | February 1997 | Martin | 84/743. |

### BACKGROUND OF THE INVENTION

1. Field of the Invention

This invention is a portable stage/platform for musicians, dancers or storytellers to perform upon who wish to have the movement of their feet amplified. Even though it is not technically a musical instrument or a drum, one may be capable of creating drum like sounds.

2. Description of Prior Art

The prior art consists of regular stages and platforms too large to carry around.

The prior art consists of standard amplified and electronic drums, percussion, and the ‘acoustical rhythm board’ none of which are meant to be stood or danced on.

### SUMMARY OF INVENTION

The Stomp Stage is basically the portable equivalent of having a microphone or sound pick-up mounted under the floor of a stage or platform to amplify the movement above.

Ideal for the solo musician or dancer wanting the rhythm created by their feet to be amplified. Also for a story teller who, for an example, can use their footsteps as sound effects.

The Stomp Stage also serves as a little stage or platform for a performer where there is no stage or platform to perform on.

### DESCRIPTION OF THE DRAWINGS

FIGS. 1-10 (the desired material being molded plastic and the desired size and shape being 2 ft square with sloped sides)

FIG. 1: The top view of the Stomp Stage.

FIG. 2: The front view of the Stomp Stage.

FIG. 3: The side view of the Stomp Stage.

FIG. 4: The underneath view of the Stomp Stage.

FIG. 5: A cross section of the side view of the Stomp Stage.

FIG. 6: The underneath view of a two-microphone Stomp Stage.

FIG. 7: A cross section of the front view of a two-microphone Stomp Stage.

FIG. 8: A cross section of the back view of a two-microphone Stomp Stage.

FIG. 9: The underneath view of the unwired Stomp Stage.

FIG. 10: A cross section of the side view of the unwired Stomp Stage.

FIGS. 11-18 (the desired material being wood and the desired size and shape being 2 ft square without sloped sides)

FIG. 11: The top view of the wooden Stomp Stage.

FIG. 12: The side view of the wooden Stomp Stage.

FIG. 13: The top view of the wooden Stomp Stage showing how the top is mounted.

FIG. 14: The underneath view of the wooden Stomp Stage.

FIG. 15: The underneath view of an unwired wooden Stomp Stage.

FIG. 16: A close up view of the microphone housing of the unwired wooden Stomp Stage without a microphone.

FIG. 17: A close up view of the microphone housing of the unwired wooden Stomp Stage with a microphone inserted.

FIG. 18: A drawing of a standard microphone for a point of reference with and without its' wind screen.

### DETAILED DESCRIPTION OF THE STOMP STAGE

The Stomp Stage is simply an extremely portable stage or platform rigged with a microphone or sound pick-up situated inside and just underneath the top of the stage/platform so as to amplify the rhythm of the feet while performing on top of the said stage/platform. Even though it can be constructed to be any desired size or shape this particular design will be just big enough for one performer to perform comfortably upon.

Being two foot square, a 1/2 inch thick and 2 inches high weighing only a few pounds also makes this design so portable that the performer can easily carry it under his or her arm.

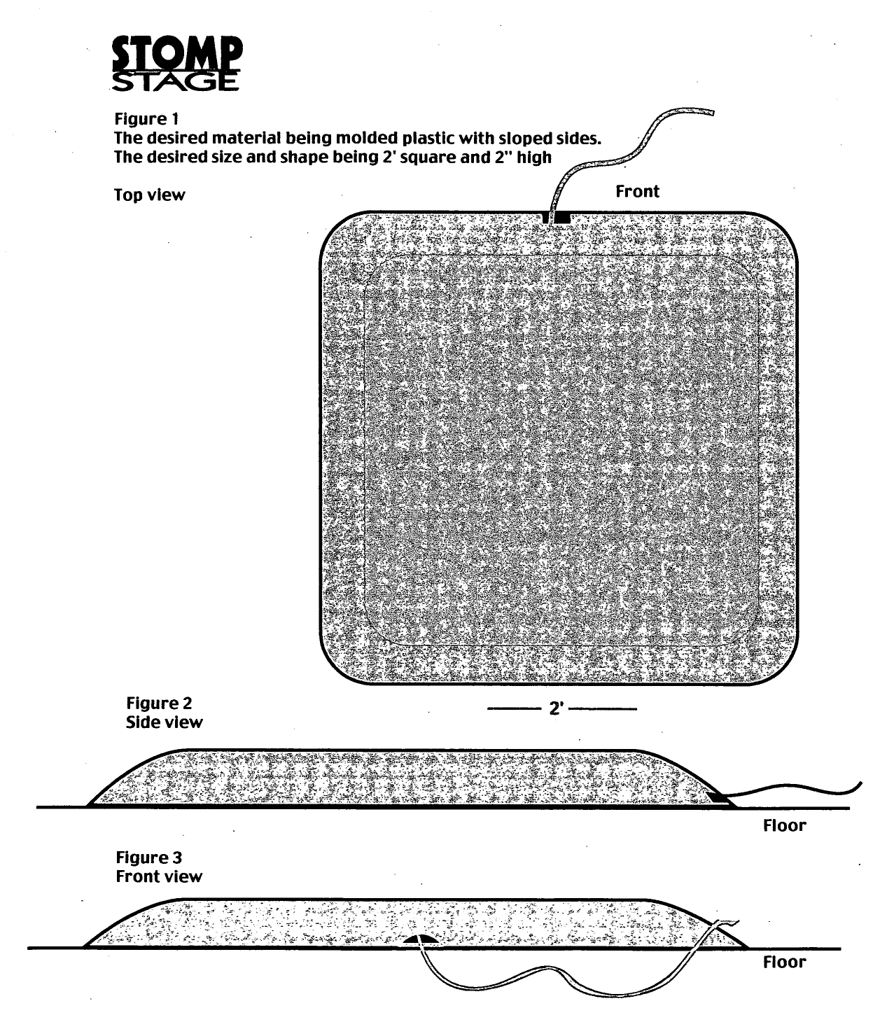

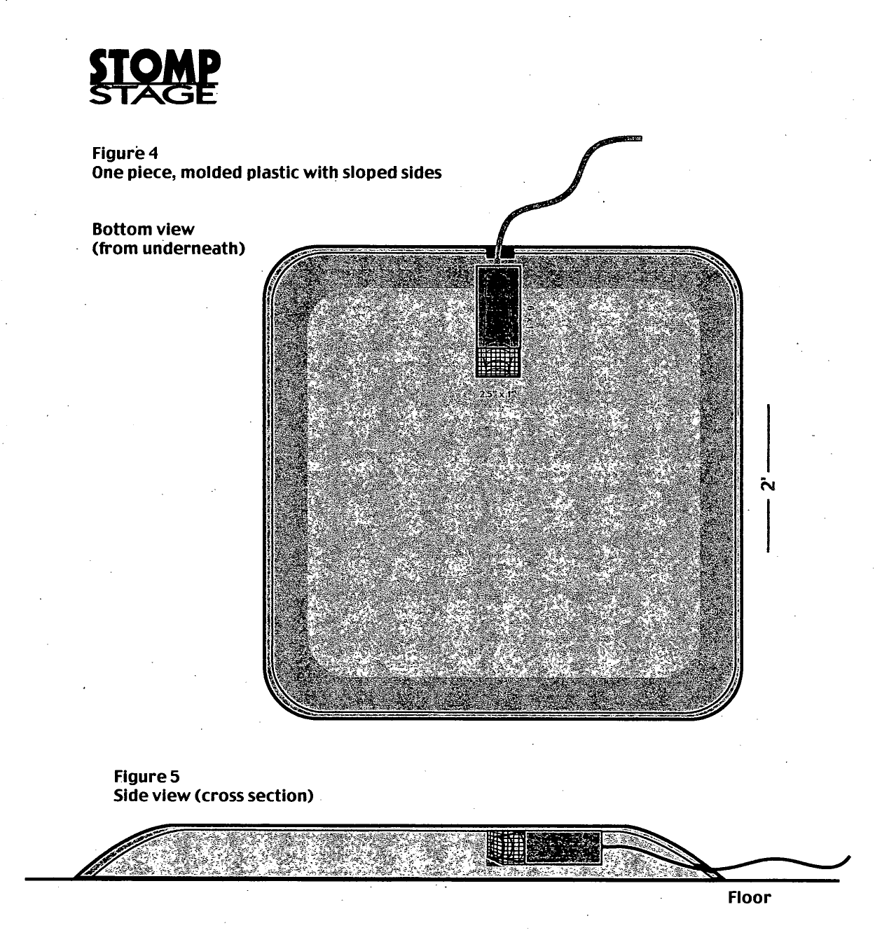

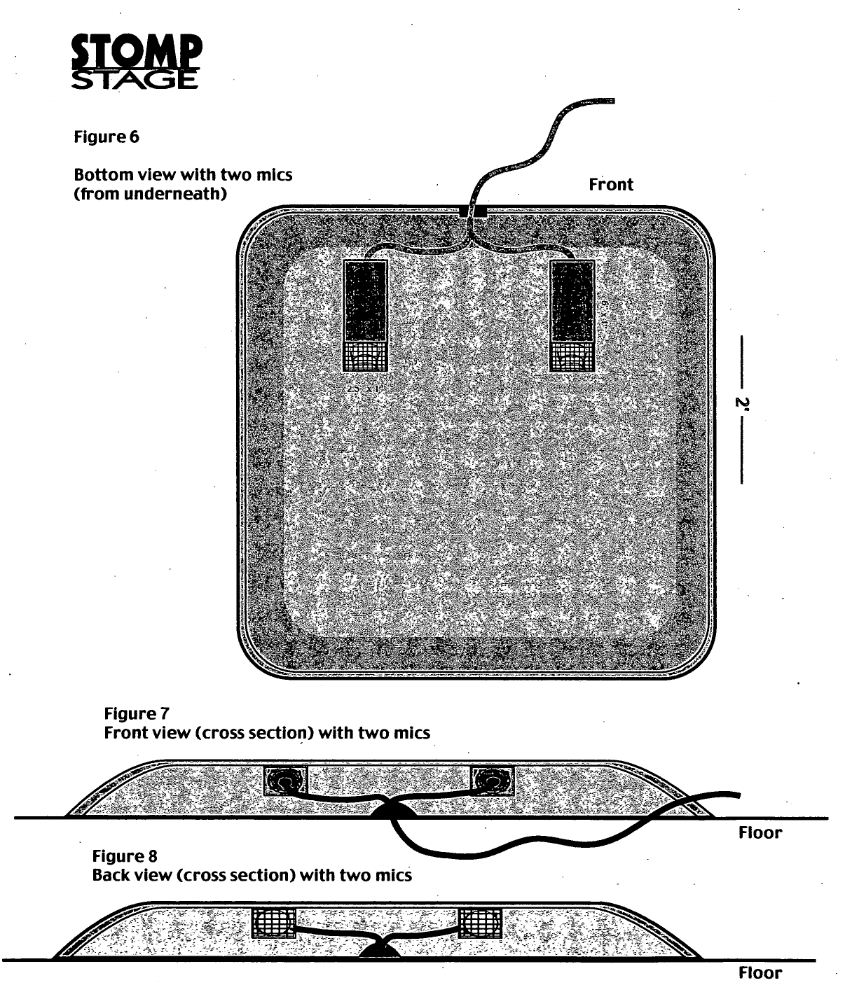

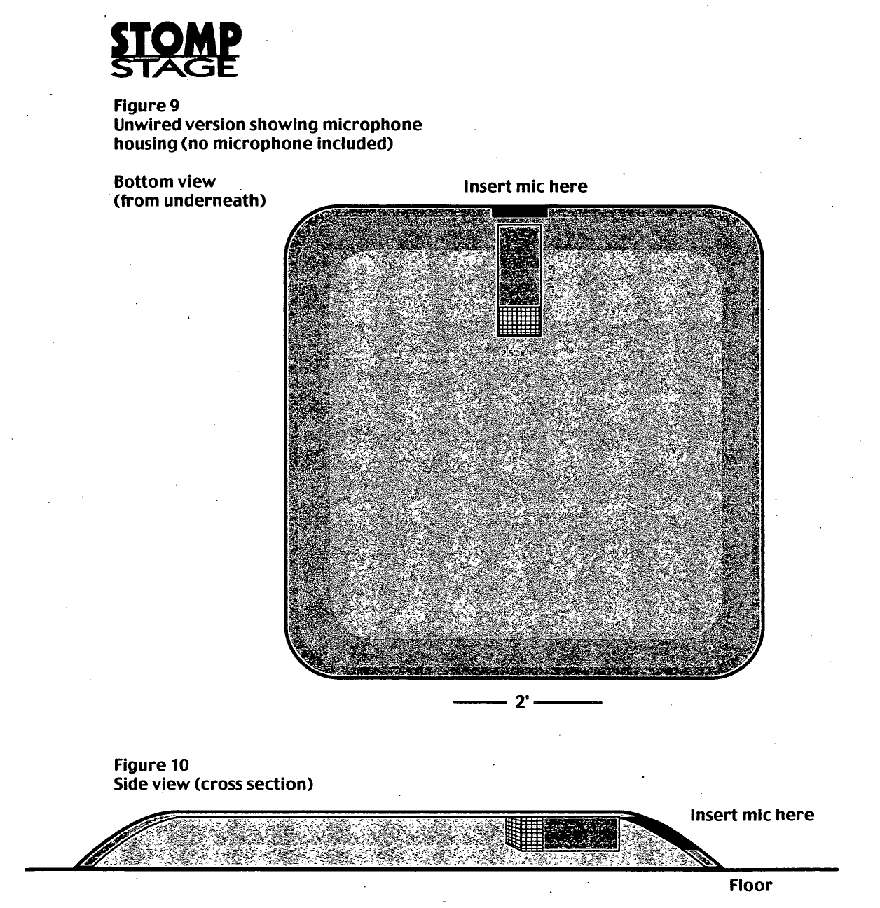

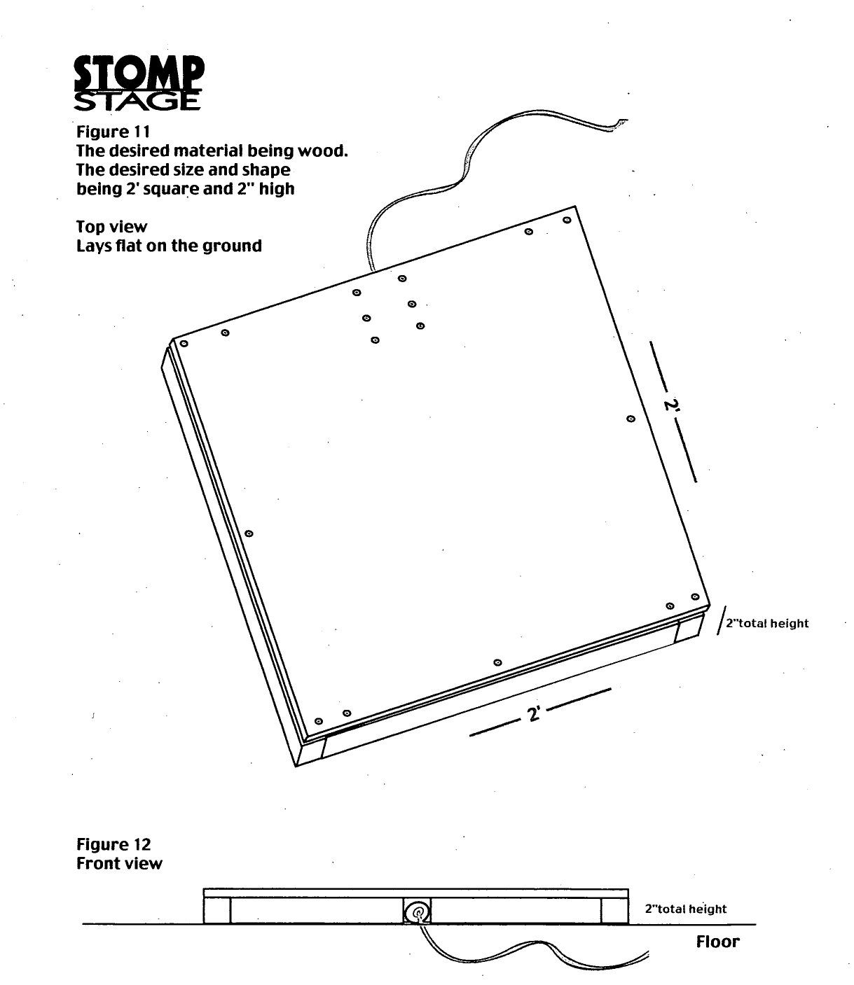

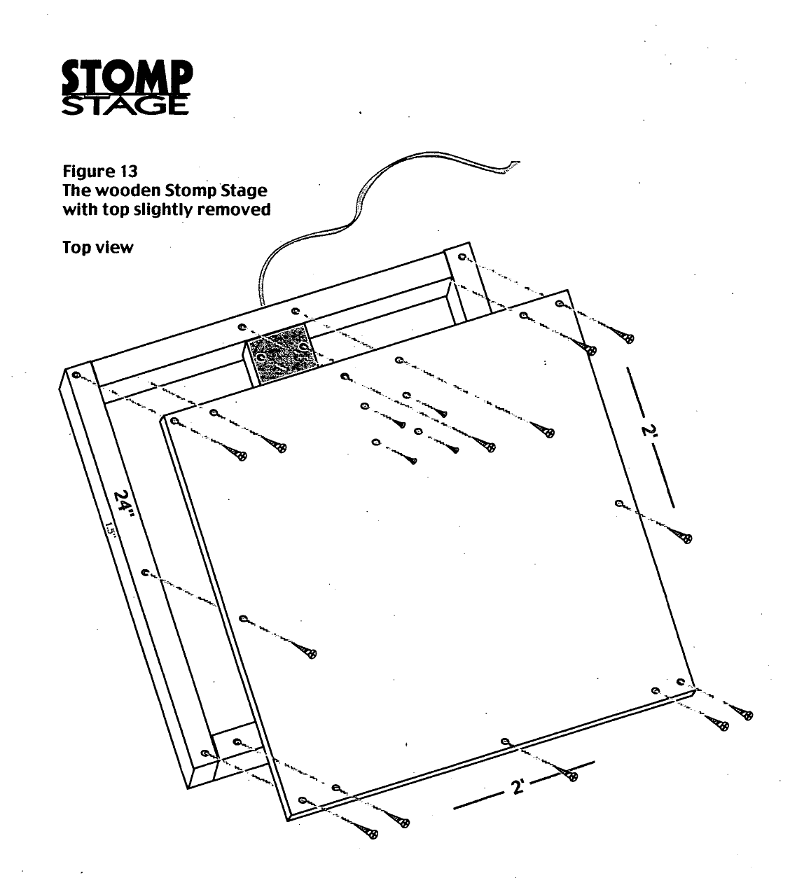

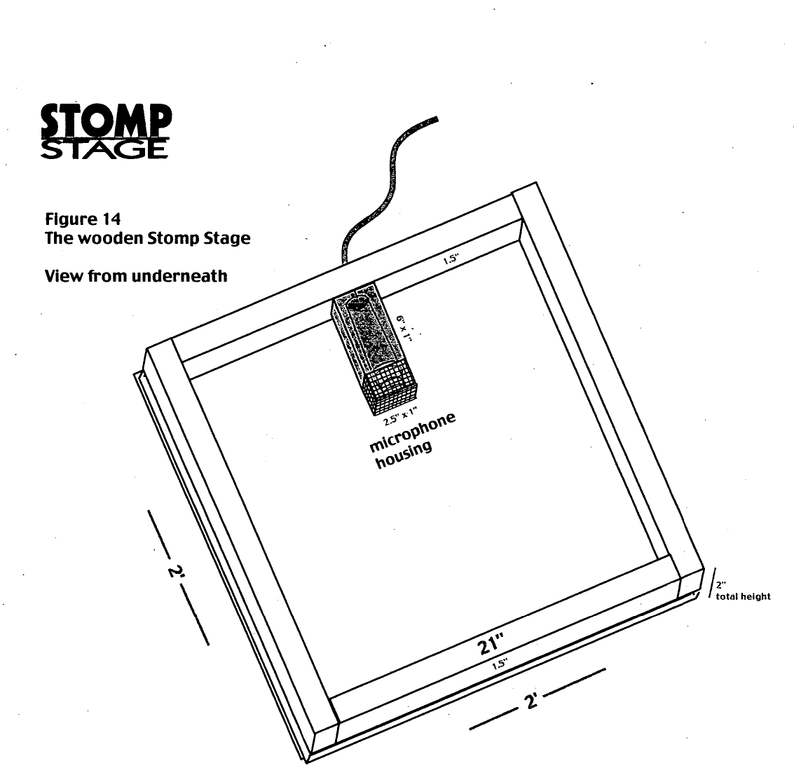

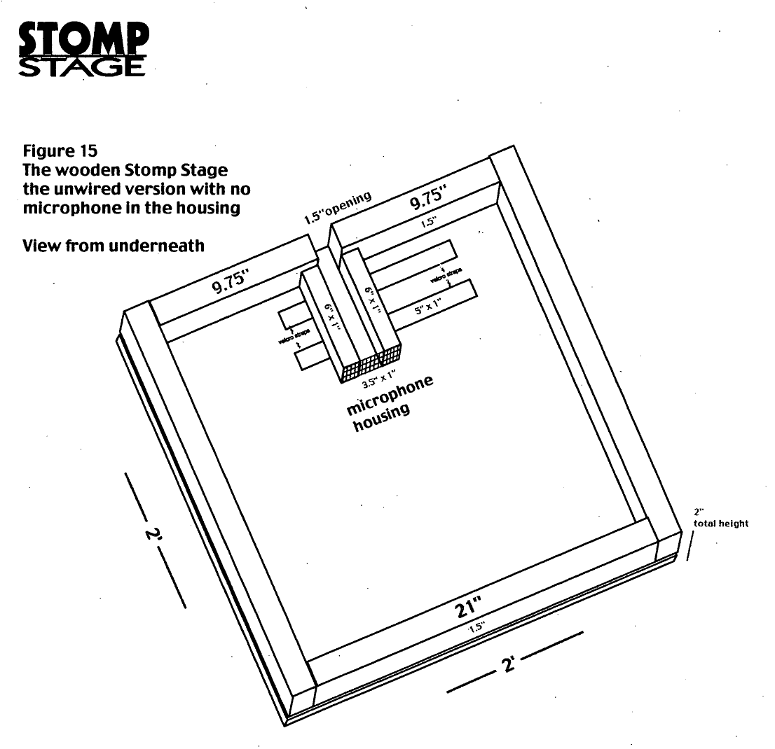

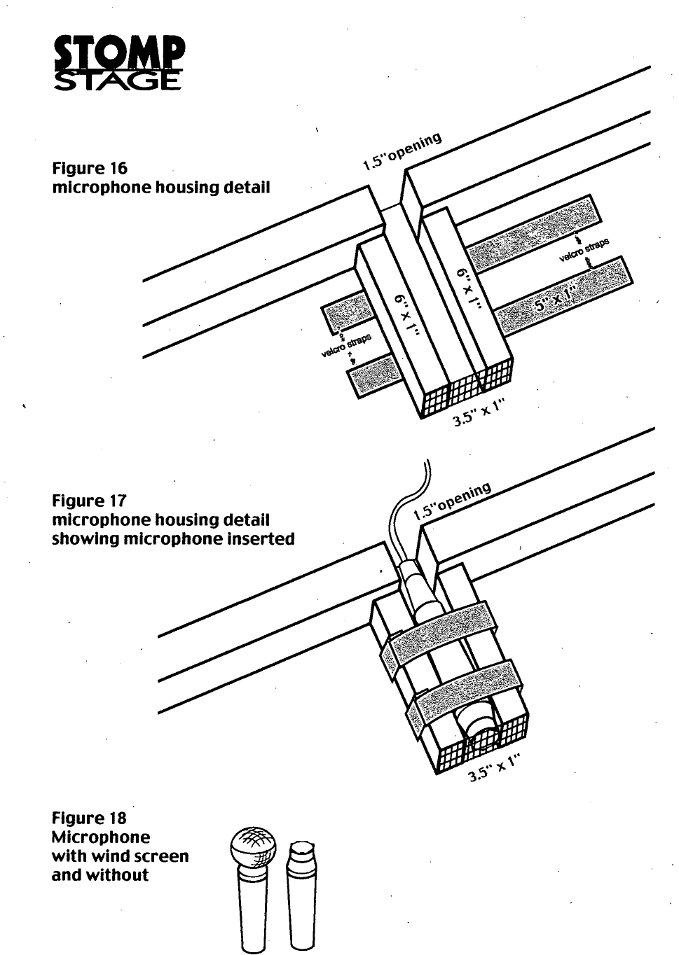

Though it can be constructed with any hard surfaced material such as plastic, metal, hard rubber or wood, the desired materials in the drawings are plastic, cast from a mold and wood. FIGS. 1, 2, & 3 are the top, front, and side views of the Stomp Stage. Being a two foot square plastic platform, 2 inches high and having sloped sides, with a standard 1/4 inch cable coming out from one side to plug into an amp or mixer board. The 1/4 inch cable is connected to a microphone or sound pick-up mounted inside and underneath the Stomp Stage. FIG. 4 shows an underneath view of the Stomp Stage and how the microphone sits in its' protective housing which is a part of the mold design. FIG. 5 shows where the microphone housing is strategically situated under the top and bordering the front side of the Stomp Stage for optimum amplification. FIG. 6 is the same under-view as FIG. 4 but shows how the use of two microphones might be situated underneath for a more balanced amplification. FIGS. 7 & 8 show where the two microphone housings are strategically situated under the Stomp Stage for optimum amplification. FIGS. 9 & 10 show the underneath view of the unwired Stomp Stage with no microphone inserted in the mic housing. FIG. 11 is the top view of a wooden Stomp Stage without sloped sides. FIG. 12 shows the front view of a wooden Stomp Stage ready for use. FIG. 13 shows how the top of a wooden Stomp Stage is mounted (using screws or nails) onto a frame of wooden 2×2's. FIG. 14 shows what the underneath view of the wooden Stomp Stage with a microphone in its' protective housing situated under the top and front side of the Stomp Stage for optimum amplification. FIG. 15 is an underneath view of the unwired wooden Stomp Stage with no microphone inserted. FIG. 15 also shows an 1 ½ inch wide opening in the middle of the front side of the 2×2 frame where the microphone (sans windscreen) is to be inserted. FIG. 16 is a close up of an empty Microphone housing which consists of two one inch square wooden rods, six inches long, situated to support the microphone on each side and having two velcro strips attached to the rods, situated to strap across the microphone to secure it in place. Also having a piece of screen mounted on the end of the rods to prevent the microphone from slipping all the way through once inserted. The 0.5 microphone housing can either be glued, nailed or screwed into place. FIG. 17 is a close up view of the microphone housing with a microphone inserted and secured in place by two strips of velcro. FIG. 18 is a drawing of a standard microphone with and without its' windscreen. (shown as a point of reference) Most microphones would not fit into the microphone housing without removing the wind screen unless a larger version of the Stomp Stage was built.

Besides being able to amplify the rhythm of the feet the Stomp Stage serves as a little stage or platform for a performer where there is no stage or platform to perform on.

The prior art of electronic drums and percussion or the acoustical rhythm board would be too small to stand on let alone dance upon for a dancer whose desired effect during a performance would be to hear the rhythm created by their feet. In the past, to achieve the desired effect, the performer would have a microphone placed near or on the ground as close to the feet as possible. But if the stage was carpeted or concrete the rhythm created by their feet wouldn't be as pronounced as desired so the performer would have to turn the microphone way up which would often lead to unwanted feed back. With the microphone located directly under the feet, it only picks up the percussive sounds created by the feet while performing on the Stomp Stage as opposed to picking up unwanted sounds from the stage or surrounding room.

What I claim as my invention is:

1. A portable stage/platform being square, circle or whatever desired shape but large enough for one person to perform comfortably upon, being approximately 2 feet square or circumference or larger and 1/2 inch high or higher, 1/4 inch thick or thicker, made out of, or any combination of, either plastic, metal, hard rubber, wood or any other hard surfaced material comprising of one or more dynamic micro-phones or their components or sound pick-ups, mounted underneath the stage to amplify the movement of the feet.

2. A portable stage/platform as claimed in claim 1 mounted onto plastic, metal, hard rubber or wood built just high enough for the said dynamic microphone or its' components or sound pick-up to be affixed underneath.

3. A portable stage/platform as claimed in claim 2 having sloped sides if deemed necessary for safety and surer footing.

4. A portable stage/platform as claimed in claim 3 wherein said dynamic microphone or it's components are encaged in a protective housing made out of plastic, metal, hard rubber or wood.

5. A portable stage/platform as claimed in claim 4 wherein said dynamic microphone or its' components or sound pick-up is connected to a cable with either standard XLR connectors or 1/4 inch plugs to plug into either a mixer board or amplifier.
